(19) United States
(12) Patent Application Publication
(10) Pub. No.: US 2025/0181994 A1
(43) Pub. Date: Jun. 5, 2025

(54) ELECTRONIC TICKET MANAGEMENT SYSTEM, ELECTRONIC TICKET MANAGEMENT METHOD, VISITOR TERMINAL, SERVER, AND COMPUTER-READABLE RECORDING MEDIUM ON WHICH PROGRAM IS RECORDED

(71) Applicant: Rakuten Group, Inc., Tokyo (JP)

(72) Inventors: Yusuke HAYASAKA, Tokyo (JP); Chisa YAMAMOTO, Tokyo (JP)

(73) Assignee: Rakuten Group, Inc., Tokyo (JP)

(21) Appl. No.: 18/961,665

(22) Filed: Nov. 27, 2024

(30) Foreign Application Priority Data
Nov. 30, 2023 (JP) 2023-203124

(51) Int. Cl. G06Q 10/02

(52) U.S. Cl. CPC G06Q 10/02

(57) ABSTRACT

An outputter of a visitor terminal outputs ticket information associated with a ticket owned by a user. An acquirer of a gate terminal acquires the ticket information output by the visitor terminal. A provider of a server provides the visitor terminal with route information based on a route from a gate location where the gate terminal that has acquired the ticket information is located to a destination location associated with the ticket information. A presenter of the visitor terminal presents the route from the gate location to the destination location based on the route information provided by the server.

### CROSS-REFERENCE TO RELATED APPLICATIONS

This application claims the benefit of Japanese Patent Application No. 2023-203124, filed on Nov. 30, 2023, the entire disclosure of which is incorporated by reference herein.

### FIELD OF THE INVENTION

The present disclosure relates generally to an electronic ticket management system, an electronic ticket management method, a visitor terminal, a server, and a computer-readable recording medium on which a program is recorded.

### BACKGROUND OF THE INVENTION

For example, Unexamined Japanese Patent Application Publication No. 2005-025686 proposes an electronic ticketing system that causes a ticket-issuing machine to generate ticket data containing ticket information and a control program, causes the ticket-issuing machine to transmit the generated ticket data to a portable information terminal, and displays a map to a site corresponding to the ticket information based on location data contained in the ticket data and location data of the portable information terminal that is acquired by a GPS receiver (positioning device) installed in the portable information terminal.

### SUMMARY OF THE INVENTION

An electronic ticket management system according to the present embodiment is an electronic ticket management system that includes a visitor terminal and a gate terminal, wherein
a processor of the visitor terminal outputs ticket information associated with a ticket,
a processor of the gate terminal acquires the ticket information output by the visitor terminal,
the processor of the visitor terminal or the processor of the gate terminal provides the visitor terminal with route information that is information based on a route from a gate location where the gate terminal that has acquired the ticket information is located to a destination location associated with the ticket information, and
the processor of the visitor terminal presents the provided route information.

### BRIEF DESCRIPTION OF DRAWINGS

A more complete understanding of this application can be obtained when the following detailed description is considered in conjunction with the following drawings, in which:

FIG. 1 is a block diagram illustrating a configuration of an electronic ticket management system according to the present embodiment;

FIG. 2 is a functional block diagram of the electronic ticket management system according to the present embodiment;

FIG. 3 is a sequence diagram illustrating an admission sequence at an admission gate of a venue;

FIG. 4 is a diagram illustrating an example of a hardware configuration of an information-processing device serving as a component of the electronic ticket management system according to the present embodiment;

FIG. 5 is a flowchart illustrating an example of processing during starting a ticketing app startup;

FIG. 6 is a flowchart illustrating an example of processing when receiving ticket information;

FIG. 7A is a diagram illustrating an example of information stored on a server;

FIG. 7B is a diagram illustrating an example of information stored on the server;

FIG. 7C is a diagram illustrating an example of information stored on the server;

FIG. 7D is a diagram illustrating an example of information stored on the server;

FIG. 8 is a diagram illustrating an example of an overall map of a venue;

FIG. 9A is a diagram illustrating an example of a screen displayed in a visitor terminal;

FIG. 9B is a diagram illustrating an example of a screen displayed in the visitor terminal;

FIG. 9C is a diagram illustrating an example of a screen displayed in the visitor terminal; and

FIG. 9D is a diagram illustrating an example of a screen displayed in the visitor terminal.

### DETAILED DESCRIPTION OF THE INVENTION

An electronic ticket management system 100 according to an embodiment of the present disclosure is described below with reference to the drawings. Same or equivalent elements in figures are denoted by same reference signs.

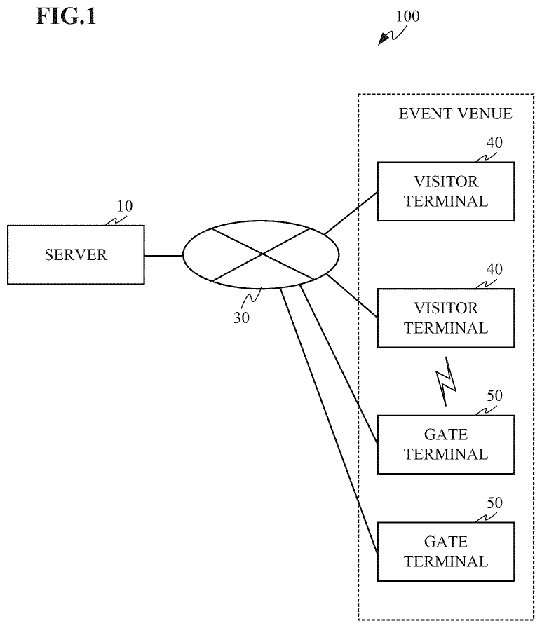

FIG. 1 is a block diagram illustrating a configuration of an electronic ticket management system 100 according to the present embodiment. The electronic ticket management system 100 is a system for managing whether to grant entry to an event (event venue) on the basis of an electronic ticket associated with a visitor terminal 40 (for example, an electronic ticket owned by a user). The electronic ticket management system 100 outputs, to the visitor terminal 40 located in the event venue, information on a route to a predetermined location (for example, a seat location for a user of the visitor terminal 40) associated with the electronic ticket. The user who enters the event venue is also referred to as a visitor. The electronic ticket management system 100 according to this embodiment includes a server 10, the visitor terminal 40, and a gate terminal 50, all of which are connected with each other via a communication network 30 such as the Internet or a mobile communication network. The server 10 and the visitor terminal 40 transmit and receive information between them via the communication network 30. The server 10 and the gate terminal 50 transmit and receive information between them via the communication network 30.

The server 10 manages ticket information associated with a ticket to the event electronically owned by the user. The server 10 manages entry of the user to the event venue based on the ticket information. The server 10 performs authentication of the ticket by determining, for example, whether the ticket associated with the ticket information is valid on the basis of the ticket information received from the gate terminal 50, and transmits the result of authentication to the gate terminal 50. In this manner, the gate terminal 50 can verify validity of the presented electronic ticket.

The server 10 provides a ticketing app that is an application having a function to purchase a ticket to an event, a function to display the ticket (electronic ticket) at the event venue, and the like. The visitor terminal 40 can access the server 10 through the ticketing app. The server 10 provides a service corresponding to each function of the ticketing app.

The ticketing app may have a function such as providing information on an event related to a subject supported by a user, broadcasting an event live, broadcasting an event in a recorded form, displaying a message from the subject supported by the user, displaying a result and an achievement of the subject supported by the user, enabling interaction between fans by using the app, or purchasing merchandise online. The ticketing app also outputs information related to a route to a seat location in an event that the user attends.

The server 10 is a high-performance information-processing device that may include a plurality of storage devices or a plurality of controllers such as CPUs. The server 10 may be constructed from an information-processing device capable of performing communication such as a personal computer (PC) or a workstation. The server 10 may be a dedicated device. The server 10 may be constructed from a plurality of information-processing devices.

The visitor terminal 40 is an information-processing device that the user can carry such as a smartphone or a tablet. A ticketing app provided by the server 10 can be installed on the visitor terminal 40. The visitor terminal 40 displays an electronic ticket or information related to the ticket on a display screen in accordance with a user operation on the installed ticketing app. An electronic ticket contains, for example, date and time of an event, information related to a seat location, a ticket code consisting of a two-dimensional code, a barcode, or the like, all of which are associated with the electronic ticket. In a more limited sense, a ticket code displayed on the visitor terminal 40 is also referred to as the electronic ticket.

The visitor terminal 40 according to this embodiment can display route information from an admission gate of an event venue to a seat of a user when the user enters the event venue through the gate terminal 50 by using the electronic ticket. Details of processing for displaying the route information and operations are described below.

The gate terminal 50 is a terminal device including, at least, a code reader for scanning the ticket code, a communication function for communication with the server 10, an output means for outputting an authentication result from the server 10 (a display screen, a speaker, or the like). The gate terminal 50 performs authentication of a ticket by scanning a ticket code included in an electronic ticket or printed on a paper ticket and transmitting a ticket authentication request based on the scanned ticket code to the server 10.

Specifically, the gate terminal 50 scans the ticket code included in the electronic ticket that is displayed on the visitor terminal 40 and presented by an operation of a visitor or the ticket code printed on the paper ticket and transmits a ticket authentication request based on the scanned ticket code to the server 10. The server 10 performs an authentication process based on information contained in the received ticket authentication request and transmits the authentication result to the gate terminal 50. When the gate terminal 50 receives the authentication result from the server 10, the gate terminal 50 displays the authentication result on the display screen or outputs a sound in accordance with the authentication result.

The gate terminal 50 may be a handheld terminal carried by a staff member at an admission gate, a stationary gate device (automatic ticket gate) with a door or a rod that can be opened and closed, or the like. When the gate terminal 50 is a handheld terminal, the staff member may grant or reject entry of the visitor to the venue in accordance with the authentication result output by the gate terminal 50. When the gate terminal 50 is a stationary gate device, the gate terminal 50 may grant or reject entry of the visitor to the venue in accordance with the authentication result output by the gate terminal 50 by opening or closing the door or the rod.

In FIG. 1, although two visitor terminals 40 and two gate terminals 50 are illustrated, the number of the visitor terminals 40 and the number of the gate terminals 50 may be any given number. A predetermined number of the gate terminals 50 may be provided at each admission gate of the event venue. A plurality of the gate terminals 50 may be provided in the event venue.

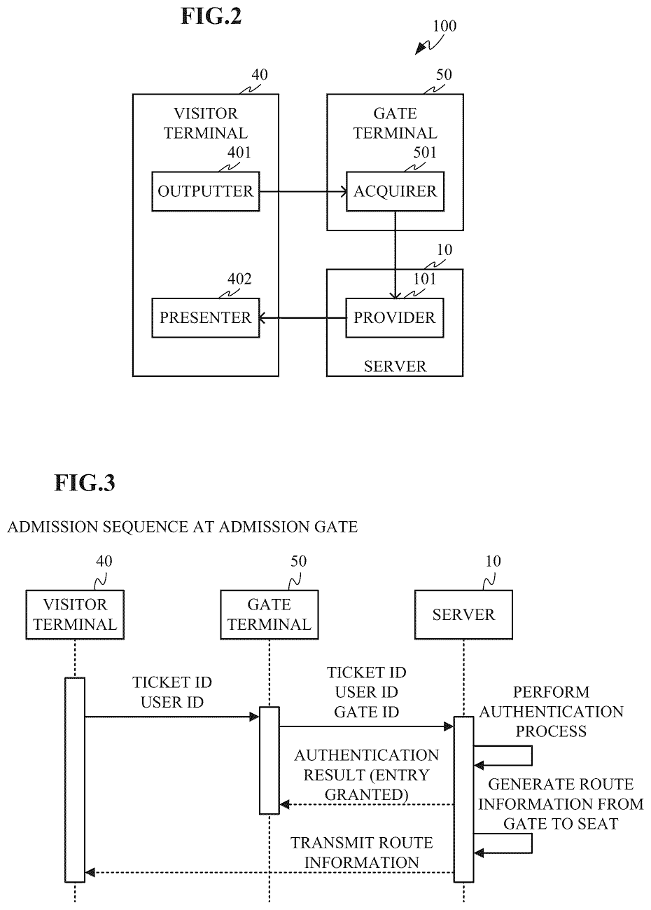

FIG. 2 is a functional block diagram of the electronic ticket management system 100 according to the present embodiment. As illustrated in FIG. 2, the electronic ticket management system 100 includes the server 10, the visitor terminal 40, and the gate terminal 50. The server 10 includes a provider 101. The visitor terminal 40 includes an outputter 401 and a presenter 402. The gate terminal 50 includes an acquirer 501.

As a result of the ticketing app operating on the visitor terminal 40, the outputter 401 of the visitor terminal 40 outputs ticket information associated with a ticket owned by the user (visitor). It should be noted that the ticket owned by the user mentioned here is an example of a ticket associated with the visitor terminal 40. For example, the outputter 401 displays an electronic ticket (ticket code) on a display screen (an output device such as a display of the visitor terminal 40). The outputter 401 may output the ticket information by means of wireless communication.

The acquirer 501 of the gate terminal 50 acquires the ticket information output by the visitor terminal 40. For example, the acquirer 501 acquires the ticket information associated with the electronic ticket by scanning the electronic ticket output by the outputter 401. The gate terminal 50 transmits a ticket authentication request based on the ticket information acquired by the acquirer 501 to the server 10. The acquirer 501 may acquire the ticket information from the visitor terminal 40 by means of wireless communication.

The provider 101 of the server 10 provides the visitor terminal 40 with route information that is information based on a route from a gate location where the gate terminal 50 that has acquired the ticket information is located to a destination location associated with the ticket information. For example, the provider 101 identifies the gate location of the gate terminal 50 that has transmitted the ticket authentication request based on the ticket information, and identifies the destination location (seat location) associated with the ticket information. The provider 101 generates a route (lines) connecting the gate location to the destination location based on map information of the venue, the route information, and the like, and transmits and provides route information based on the generated route to the visitor terminal 40.

The presenter 402 of the visitor terminal 40 presents the route from the gate location to the destination location based on the route information provided by the server 10. For example, the outputter 401 displays a route connecting the admission gate to the seat on the display screen.

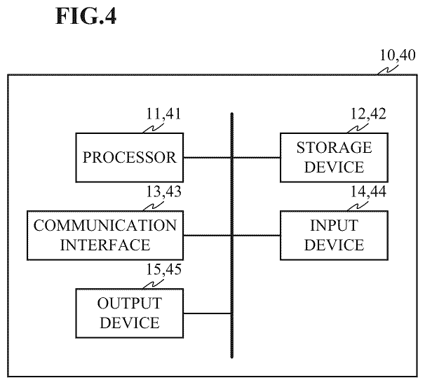

FIG. 3 is a sequence diagram illustrating an admission sequence in the electronic ticket management system 100. As illustrated in FIG. 3, when the visitor holds the electronic ticket displayed on the visitor terminal 40 over the code reader of the gate terminal 50 at the admission gate, the gate terminal 50 scans a ticket ID that is ticket identifying information and a user ID that is user identifying information, both of which are contained in the electronic ticket. In this case, the ticket ID serves as the ticket information. Subsequently, the gate terminal 50 transmits a ticket authentication request containing the ticket ID and the user ID that have been scanned and a gate ID that is identifying information of the gate terminal 50 itself to the server 10. When the server 10 receives the ticket authentication request containing the ticket ID, the user ID, and the gate ID, the server 10 executes processing for authenticating the ticket, for example, by checking a ticket identified from the ticket ID against the ticket owned by the user that is identified from the user ID and transmits the authentication result to the gate terminal 50. In this case, it is assumed that the authentication result is successful, in other words, entry is granted. When the gate terminal 50 receives the authentication result indicating that the entry is granted, the gate terminal 50 displays the authentication result on a display device included in the gate terminal 50 or at the admission gate, and performs control for permitting the user to enter the event venue, for example, by opening a gate door. Alternatively, a staff member may guide the user into the event venue in accordance with the authentication result displayed on the display device. When the authentication of the ticket is successful, the server 10 generates a route connecting the gate location of the admission gate identified from the gate ID to the seat location associated with the ticket ID, and transmits route information based on the generated route to the visitor terminal 40.

The electronic ticket management system 100 according to the present embodiment as described above can generate, when the user enters the event venue through the gate terminal 50 by using ticket information output by the visitor terminal 40, that is, an electronic ticket, route information based on the gate location identified by the gate terminal 50 and the seat location identified from the ticket information, and provide the visitor terminal 40 with the route information from the gate location to the seat location. In other words, the visitor can automatically acquire the route information from the admission gate to the seat location by entering the event venue by using the electronic ticket. In this manner, even when a current location cannot be identified by the visitor terminal 40, for example, due to poor reception at the positioning device, the electronic ticket management system 100 can reliably provide route information inside the venue to the visitor terminal 40, and appropriately guide the visitor to the seat location.

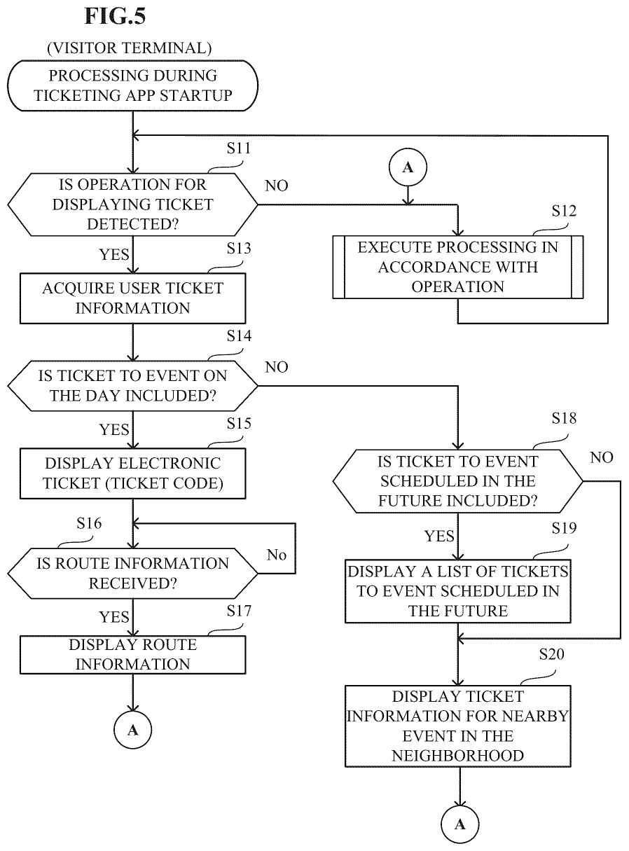

FIG. 4 is a diagram illustrating an example of a hardware configuration of an information-processing device serving as a component of the server 10 and the visitor terminal 40. The server 10 includes: a processor 11 such as a Central Processing Unit (CPU) or a Graphical Processing Unit (GPU); a storage device 12 such as a memory, an HDD, or an SSD; a communication interface 13 that performs a wire or wireless communication; an input device 14 that receives an input operation; and an output device 15 that outputs information. The input device 14 is, for example, a keyboard, a touchscreen, a mouse, and/or a microphone. The output device 15 is, for example, a display and/or a speaker.

The visitor terminal 40 similarly includes: a processor 41; a storage device 42; a communication interface 43; an input device 44; and an output device 45. It should be noted that a component unnecessary in the server 10 or the visitor terminal 40 may be appropriately omitted and a component other than those described above may be added. The gate terminal 50 also has the hardware configuration of the information-processing device illustrated in FIG. 4.

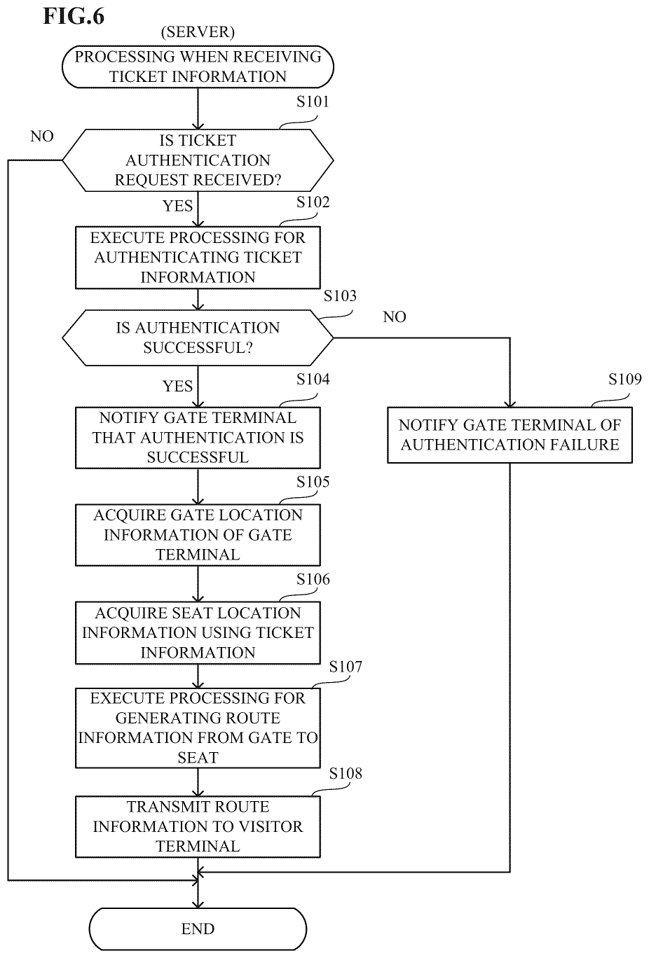

Next, operations of the electronic ticket management system 100 are described. FIG. 5 is a flowchart illustrating an example of processing during the ticketing app startup executed by the visitor terminal 40. The processing during the ticketing app startup is executed, for example, by the processor 41 of the visitor terminal 40 loading a program stored in the storage device 42.

The processing during the ticketing app startup is a process executed by the visitor terminal 40 when the ticketing app is startup. In this processing, the processor 41 of the visitor terminal 40 determines whether an operation for displaying a ticket by the user of the visitor terminal 40 is detected (step S11). The operation for displaying a ticket may be a predetermined operation performed on a screen of the ticketing app.

When the operation for displaying a ticket is not detected (step S11: No), the processor 41 executes processing in accordance with an operation by the user (step S12). In step S12, the processor 41 executes processing for searching for, purchasing, or transferring a ticket, importing a paper ticket into the ticketing app, or the like in accordance with the operation by the user on the ticketing app. After the processing in step S12, the processor 41 returns to step S11 and repeats step S11 and step S12, for example, until an operation for exiting the ticketing app is detected in step S12.

When the operation for displaying a ticket is detected (step S11: Yes), the processor 41 acquires user ticket information associated with the user ID of the user of the visitor terminal 40 from the server 10 (step S13).

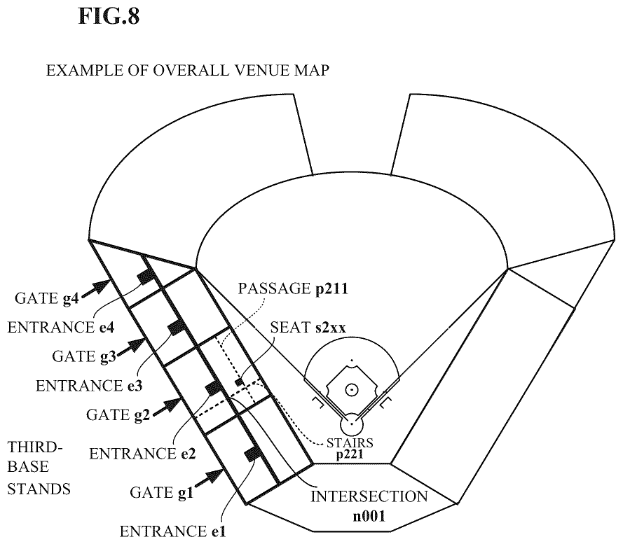

FIG. 7A illustrates an example of user ticket information stored in the storage device 12 of the server 10. The user ticket information is information that indicates ticket information owned by a predetermined user. The user ticket information is, for example, information obtained by associating the user ID that uniquely identifies the user, the ticket ID that uniquely identifies a ticket to an event, the date and time of the event (date, period, time, or the like), the event venue of the event (a name of the venue, location information, or the like), and a seat ID that identifies the seat location in the event venue (a seat number, a seat type, block, row, passage, or the like) with each other as illustrated in FIG. 7A. When the user owns a plurality of tickets, a plurality of the ticket IDs just has to be associated with the user ID. When the user purchases a ticket by means of an electronic method from a website or in an application or the like provided by the server 10, user ticket information associated with the ticket is registered on the storage device 12. The user ticket information is referred to for authentication, for example, when the user enters the event venue by using the electronic ticket. The user ticket information may contain other information. The ticket ID associated with the user ID is not limited to an ID of the ticket that the user has purchased, but may be an ID of a ticket transferred by means of a predetermined method.

Referring back to FIG. 5, in this embodiment, when detecting the operation for displaying a ticket, the visitor terminal 40 (ticketing app) is configured to display different information depending on date and time associated with one or more tickets owned by the user. The processor 41 determines, upon acquiring the user ticket information, whether a ticket to an event on the day is included in the one or more tickets owned by the user, for example, by referring to the date and time of the event in the user ticket information and the current time (step S14). In other words, in step S102, the processor 41 determines whether the current time corresponds to an admission time of any one of the one or more tickets owned by the user.

When a ticket to an event on the day is included (step S14: Yes), in other words, when the current time corresponds to the admission time of any one of the one or more tickets owned by the user, the processor 41 displays an electronic ticket (event information, seat information, a ticket code, or the like) for the ticket on the display screen (display) of the visitor terminal 40 (step S15). After step S15, the user causes the gate terminal 50 to scan the electronic ticket displayed on the visitor terminal 40. In this manner, when the user owns a ticket to an event on the day, the processor 41 displays the electronic ticket for the ticket since it is expected that the user enters the event venue by using the ticket. The user can enter the event venue by holding the electronic ticket over the gate terminal 50 at the admission gate.

In this case, by referring to the current time and an opening time of the event venue (admission time), the processor 41 may display, when the current time is before the opening time, only the event information and the seat information while omitting the ticket code for entering the venue since entry to the venue is not possible. The opening time may be contained in the user ticket information illustrated in FIG. 7A, or the opening time may be calculated from the date and time of the event. The opening time may be the same as the date and time of the event.

Subsequently, the processor 41 stands by until the processor 41 receives the route information generated by the server 10 that receives the ticket authentication request containing the ticket ID or the like from the gate terminal 50 (step S16). When an operation for terminating display of the electronic ticket is received, the processor 41 may terminate display of the electronic ticket.

When the processor 41 receives the route information from the server 10 (step S16: Yes), the processor 41 presents, to the visitor, a route from the admission gate to the seat location, for example, by displaying a route image based on the route information on the display screen of the visitor terminal 40 (step S17).

After the processing in step S17 is completed, the processor 41 proceeds to processing in step S12. After the processing in step S17, the processor 41 may proceed to processing in step S18 and execute processing for a ticket other than the ticket to an event on the day.

When a ticket to an event on the day is not included (step S14: No), in other words, when the current time does not correspond to the admission time of any one of the one or more tickets owned by the user, the processor 41 determines whether one or more tickets to an event scheduled in the future are included in the one or more tickets owned by the user, for example, by referring to date and time of the event in the user ticket information (step S18).

When one or more tickets to an event scheduled in the future are included (step S18: Yes), the processor 41 displays a list of the one or more tickets to the event scheduled in the future (a list of summaries of the one or more tickets or the like) on the display screen of the visitor terminal 40 (step S19). In this manner, the user can confirm the ticket to the event scheduled in the future that he or she owns.

After the processing in step S19 or when a ticket to an event scheduled in the future is not included (step S18: No), the processor 41 acquires ticket information for a nearby event to be held in the neighborhood of the current location of the visitor terminal 40 on the day or in the near future from the server 10 and displays the ticket information on the display screen of the visitor terminal 40 (step S20). The ticket information may contain content of the event, date and time of the event, a location of the event, a link for purchasing a ticket, or the like. In this manner, the event may be promoted to the user and the user may be urged to purchase a ticket. When one or more tickets to an event scheduled in the future are included, the processor 41 may display a list of the one or more tickets to the event scheduled in the future and ticket information for the nearby event. Alternatively, the processor 41 may sequentially display the list of the one or more tickets to the event scheduled in the future and the ticket information for the nearby event.

In the processing in step S20, the processor 41 acquires, for example, current location information of the visitor terminal 40 from a positioning device such as a Global Positioning System (GPS) included in the visitor terminal 40, and transmits an acquisition request for ticket information for a nearby event that is an event held at a location in the neighborhood of (within a predefined distance from) the acquired current location information to the server 10. When the server 10 receives the acquisition request, the server 10 may search a database or the like on which event information is recorded for an event by using the current location information, the current time, or the like and transmit ticket information based on the search result to the visitor terminal 40.

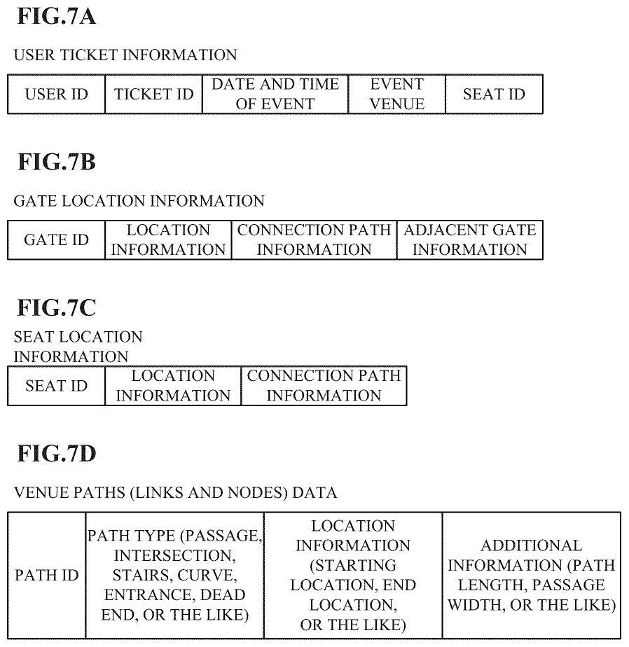

FIG. 6 is a flowchart illustrating an example of processing when receiving ticket information executed by the server 10. The processing when receiving ticket information is executed by the processor 11 of the server 10 loading a program stored in the storage device 12. In the processing when receiving ticket information, the processor 11 of the server 10 determines whether a ticket authentication request is received from the gate terminal 50 (step S101). When a ticket authentication request is not received (step S101: No), the processor 11 ends the processing when receiving ticket information. The processor 11 may return to step S101 when a ticket authentication request is not received.

When a ticket authentication request is received (step S101: Yes), the processor 11 executes processing for authenticating the received ticket information (step S102). In step S102, the processor 11 acquires, for example, user ticket information associated with a user ID contained in the ticket authentication request, and determines whether the user owns a ticket associated with the ticket ID contained in the ticket authentication request. If the user owns a ticket associated with the ticket ID contained in the ticket authentication request, authentication is successful, and if not, authentication fails.

Next, the processor 11 determines whether the authentication of the ticket information is successful (step S103). When the authentication of the ticket is successful (step S103: Yes), the processor 11 notifies the gate terminal 50 that has transmitted the ticket authentication request that the authentication of the ticket is successful (step S104).

Then, the processor 11 acquires gate location information of the gate terminal 50 that has transmitted the ticket authentication request on the basis of the gate ID contained in the ticket authentication request (step S105). In the processing in step S105, the processor 11 acquires location information associated with the gate ID on the basis of the gate ID contained in the ticket authentication request, for example, by referring to the gate location information stored in the storage device 12. In this manner, the processor 11 identifies the gate location that is a location for the visitor to enter the venue.

FIG. 7B illustrates an example of the gate location information stored in the storage device 12 of the server 10. The gate location information is, for example, information obtained by associating the gate ID that uniquely identifies the gate terminal 50, location information of the gate terminal 50 (information indicating latitude and longitude or the like), connection path information that is information on a path connected to the gate terminal 50, and adjacent gate information that is information on an admission gate adjacent to the admission gate where the gate terminal 50 is installed with each other as illustrated in FIG. 7B. The connection path information and the adjacent gate information in the gate location information are referred to when the route information is generated. The gate location information may contain other information.

The processor 11 also acquires seat location information on the basis of the ticket ID (step S106). In the processing in step S106, the processor 11 acquires a seat ID in the user ticket information, for example, on the basis of the ticket ID contained in the ticket authentication request. Then, the processor 11 acquires location information of the seat associated with the ticket ID on the basis of the seat ID by referring to the seat location information stored in the storage device 12. In this manner, the processor 11 identifies the seat location that is the destination location for the visitor.

FIG. 7C illustrates an example of the seat location information stored in the storage device 12 of the server 10. The seat location information is, for example, information obtained by associating the seat ID that uniquely identifies the seat in the event venue, the location information of the seat (information indicating latitude and longitude or the like), and connection path information that is information on a path connected to the seat (in a case where the seat is not adjacent to a path, the closest path) with each other as illustrated in FIG. 7C. The connection path information in the seat location information is referred to when the route information is generated. The seat location information may contain other information. The seat ID may contain identifying information of the event venue, or the seat location information may contain identifying information of the event venue separately.

Subsequently, the processor 11 executes route generation processing for generating route information from a location of the gate terminal 50 to the seat location (step S107).

In the processing in step S107, the processor 11 searches for a route connecting the gate location information acquired in step S105 to the seat location information acquired in step S106 (for example, the shortest route or an optimum route considering congestion) by using paths data of the venue. The processor 11 then overlays the route obtained in the search on a map of the venue and generates route information to be provided to the visitor.

For example, in this embodiment, the server 10 is configured to store information such as locations and lengths of paths (passages, intersections, stairs, or the like) in each venue as venue paths data and search for a route by using the venue paths data.

FIG. 7D illustrates an example of the venue paths data stored in the storage device 12 of the server 10. The venue paths data in this embodiment serves as path network information including nodes (points) signifying feature points of paths in a map of the venue (intersections, curves, dead ends, or the like) and links (lines) signifying paths connecting the nodes. The venue paths data is, for example, information obtained by associating a path ID that uniquely identifies a path, a path type that indicates a type of the path such as a passage, an intersection, stairs, a curve, an entrance, or a dead end, location information of the path (in a case of a passage, a starting location, an end location, or the like), and additional information indicating a length of the path, a width of a passage, or the like with each other as illustrated in FIG. 7D. The storage device 12 of the server 10 stores the venue paths data for each venue. The venue paths data may contain other information.

As the connection path information in the gate location information illustrated in FIG. 7B and the connection path information in the seat location information illustrated in FIG. 7C, the path ID is stored. In this manner, the server 10 can identify a path to be connected to the gate terminal 50 or the seat on the basis of the gate location information or the seat location information.

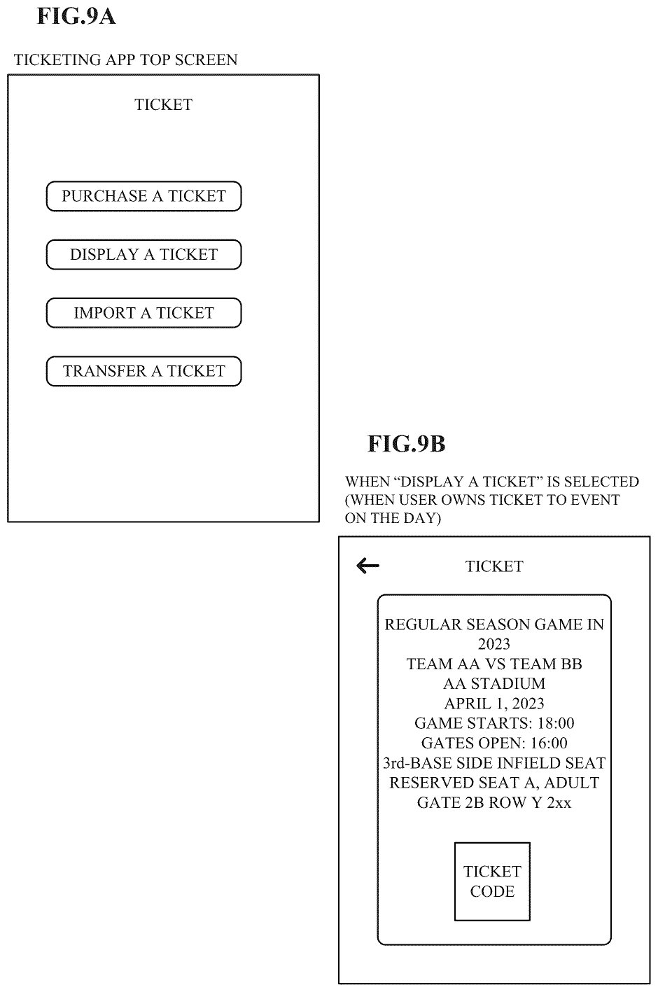

FIG. 8 illustrates an example of an overall map of a ballpark serving as an event venue. In FIG. 8, seating areas in third-base stands of the ballpark are illustrated as an example. As illustrated in FIG. 8, a plurality of admission gates, a plurality of entrances to spectators' seats, passages, stairs, intersections, and the like are provided in the ballpark. In FIG. 8, gates g1 to g4, entrances e1 to e4, a passage p211, stairs p221, an intersection n001 are illustrated. Venue paths data as illustrated in FIG. 7D may be stored in the storage device 12 for each of these paths and feature points in the venue.

Other information may be contained in the overall map, and the overall map may contain, for example, restrooms and stalls. The server 10 may store location information of the restrooms and the stalls as facility information in the storage device 12.

In this embodiment, in step S107, the processor 11 selects a path listed in the connection path information for the gate terminal 50 contained in the gate location information acquired in step S105 as a first path (starting point) and a path listed in the connection path information for the seat contained in the seat location information acquired in step S106 as a last path (end point). The processor 11 searches for a path connecting these paths (for example, the shortest route) by using the venue paths data and generates a sequence of paths by connecting the path obtained in the search to these paths. The processor 11 then overlays the generated sequence of paths on the map of the venue and generates route information to be provided to the visitor.

The map of the venue (image data) may be stored in the storage device 12 of the server 10 in advance. In step S107, a route map may be generated by overlaying the generated sequence of paths on the overall map of the venue as illustrated in FIG. 8 or a partial map of the venue (map of an area around the seat or the like). The map of the venue and the route information generated based on the map of the venue may be a 2D image or a 3D image, for example, when the venue has a layered structure.

The method of generating a route in step S107 is an example, and as long as route information indicating a route from the gate location where the gate terminal 50 that is used when the visitor enters the venue is located to the destination location (seat location) associated with the ticket information is generated, the route information may be generated by any given method. For example, an algorithm for generating a route based on nodes of roads and link information in a car navigation system or the like may be employed for generating the route information.

In step S107, the processor 11 is not restricted to searching for the shortest route when searching for a route, but the processor may provide the visitor with different route information based on lengths of paths, widths of passages, and congestion situations in paths contained in the venue path data. For example, the processor 11 may preferentially select a route that avoids a passage having a narrow width. For a predetermined period after the processor 11 provides route information to one visitor, the processor 11 may provide, to another visitor, route information that avoids a path associated with the route information provided to the one visitor. In this manner, it is possible to prevent a specific path in the venue from being congested or clogged.

In this case, in step S107, after generating the route information for the one visitor, the processor 11 may store the generated route information in the storage device 12 for a predetermined period. The processor 11 may then search for and generate a route for another visitor in such a way that the path (passage, entrance, stairs, or the like) included in the route information is avoided for the predetermined period.

After the route information for the one visitor is provided, it is presumed that the one visitor is browsing the route information and traveling the presented route while the route information is displayed on the visitor terminal 40. When the one visitor has closed the route information displayed on the visitor terminal 40, it is presumed that the one visitor has reached the seat. Therefore, when the processor 11 provides route information to another visitor while the route information provided to the one visitor is displayed, the processor 11 may provide, to another visitor, route information that avoids the path included in the route information presented to the one visitor. In this manner, it is also possible to prevent a specific path in the venue from being congested or clogged.

In this case, in step S107, after generating the route information for the one visitor, the processor 11 may store the generated route information and search for and generate a route for another visitor in such a way that the path (passage, entrance, stairs, or the like) included in the route information is avoided. The processor 41 monitors, for example, a status of the route information displayed on the display screen of the visitor terminal 40, and when the route information has been closed, the processor 41 notifies the server 10 accordingly. When the server 10 receives that the route information provided to the visitor terminal 40 of the one visitor has been closed, the server 10 may provide the path (passage, entrance, stairs, or the like) included in the route information to another visitor. In other words, the predetermined period may be set to a period until the route information provided to the one visitor has been closed.

The processor 11 may change a method of searching for a route depending on the admission gate (gate terminal 50) through which the visitor enters the venue. For example, the processor 11 may change the method of searching for the route depending on whether the admission gate through which the visitor enters is the nearest one to the seat or not. For example, when the admission gate through which the visitor enters is not the nearest one to the seat, the processor 11 may first set a route to an adjacent gate nearer to the seat than the admission gate based on the adjacent gate information contained in the gate location information and subsequently search for a route from the adjacent gate to the seat location. In this manner, even when the visitor enters the venue from an admission gate other than the one nearest to the seat, the electronic ticket management system 100 can appropriately guide the visitor to the seat.

The processor 11 then transmits the route information generated in step S107 to the associated visitor terminal 40 (step S108), and ends the processing when receiving ticket information. Information on the visitor terminal 40 that is a destination to which the route information is transmitted may be identified from the user ID contained in the ticket authentication request. For example, the server 10 may separately store the information on the visitor terminal 40 in association with the user ID in the storage device 12.

In the authentication process in step S102, when the authentication of the ticket fails (step S103: No), the processor 11 notifies the gate terminal 50 that has transmitted the ticket authentication request that the authentication of the ticket has failed (step S109), and ends the processing when receiving ticket information.

By executing the processing when receiving ticket information as described above, the server 10 can generate the route information from the gate terminal 50 through which the visitor enters to the seat location and provide the route information to the visitor terminal 40. In this manner, the electronic ticket management system 100 can appropriately guide the visitor to the seat.

Next, examples of screens displayed in the electronic ticket management system 100 according to the present embodiment are described. Cases in which a screen related to the ticketing app is displayed on a display screen of a smartphone serving as the visitor terminal 40 are described here as examples.

In this embodiment, an example in which the event is a baseball game, and the event venue is a ballpark is described. The event may be a live concert, a sports event other than a baseball game, a fireworks display, or the like. The event venue may be a stadium, an amphitheater, an open-air site, or the like. The present embodiment may apply not only to event venues, but also to a facility in which a seat can be associated with each user.

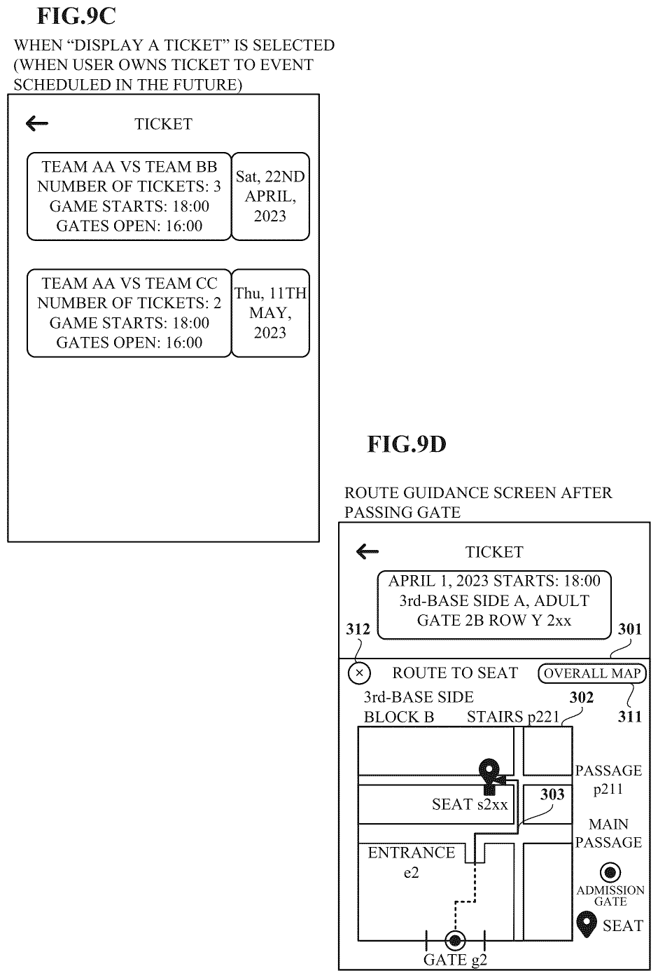

FIG. 9A illustrates a top screen of the ticketing app. When the user performs an operation for starting the ticketing app on the visitor terminal 40, the top screen of the ticketing app illustrated in FIG. 9A is displayed. On the top screen of the ticketing app, items (buttons or icons) such as “Purchase a ticket”, “Display a ticket”, “Import a ticket”, and “Transfer a ticket” are displayed. Items other than these may be included.

In FIG. 9A, when the user selects “Purchase a ticket”, the ticketing app transitions to a screen for purchasing a ticket by selecting, for example, an event name, date and time, a ticket type, or the number of tickets. When the user selects “Import a ticket”, the ticketing app transitions to a screen in which the user can import information on a paper ticket to the ticketing app, for example, by inputting a number on the paper ticket, scanning a code printed on the paper ticket, or capturing the paper ticket. When the user selects “Transfer a ticket”, the ticketing app transitions to a screen in which the user can transfer a ticket he or she owns by specifying, for example, a user name.

In FIG. 9A, when the user selects “Display a ticket”, if the user owns a ticket to an event on the day, an electronic ticket containing ticket information associated with the ticket to the event on the day and a ticket code is displayed as illustrated in FIG. 9B. When the user does not own a ticket to an event on the day, but owns one or more tickets to an event scheduled in the future, a list of summaries of the one or more tickets to the event scheduled in the future is displayed as illustrated in FIG. 9C. In the list of the one or more tickets, when one of the one or more tickets is selected, details of the ticket or an electronic ticket may be displayed.

Although an illustration is omitted, when the user does not own a ticket to an event on the day, ticket information for a nearby event to be held in the neighborhood of the current location on the day or in the near future (content of the event, date and time of the event, location of the event, a link for purchasing a ticket, or the like) is also displayed.

When the user enters the venue, while the visitor terminal 40 displays an electronic ticket as illustrated in FIG. 9B, with the electronic ticket held over the gate terminal 50, route information 301 from the location of the gate terminal 50 (location of the admission gate through which the user enters) over which the electronic ticket is held to the seat is displayed on the display screen of the visitor terminal 40 as illustrated in FIG. 9D. In the screen illustrated in FIG. 9D, ticket information indicating a seat number or the like is displayed above the route information 301.

The route information 301 illustrated in FIG. 9D contains a map of the venue 302, an overall map button 311, a close button 312, and the like. The map of the venue 302 in FIG. 9D is a partial map of the venue containing the admission gate and the seat serving as the destination location. In the map of the venue 302, a route (lines) 303 from the admission gate (“gate g2” in FIG. 9D) to the seat serving as the destination location (“seat s2xx” in FIG. 9D) is indicated. The route 303 is a route in which the visitor enters passes through the gate g2 to a concourse under the spectators' seats, enters the spectators' seats through an entrance e2, passes a main passage, stairs p221, and a passage p211, and reaches the seat s2xx. By displaying the route information 301 as described above on the visitor terminal 40 used to enter the venue, the electronic ticket management system 100 can appropriately guide the visitor to the destination location.

The route information 301 illustrated in FIG. 9D is an example, and the route information to be presented on the visitor terminal 40 may be information that at least indicates a route from the gate location where the gate terminal 50 that is used when the visitor enters the venue is located to the destination location (seat location) associated with the ticket information. In order to prevent the visitor from walking while staring at the display screen of the visitor terminal 40, the route information may be information that presents the route in a simple manner. The route information is not limited to information outputting an image indicating the route, but may be information indicating the route by means of sound, vibration, or the like instead of or in addition to outputting an image.

When the overall map button 311 in FIG. 9D is operated by the visitor, the map of the venue 302 is switched to the overall map of the venue. The overall map just has to indicate a route from the admission gate to the seat location. When the close button 312 in FIG. 9D is operated by the visitor, the route information 301 is closed and switched, for example, to the screen displaying the electronic ticket illustrated in FIG. 9B. In this case, the visitor terminal 40 may transmit to the server 10 information that the route information 301 has been closed. In this manner, the server 10 can determine, for example, whether the route information 301 is displayed on the visitor terminal 40, in other words, whether the visitor is browsing the route information 301 and traveling the route.

Since the visitor is expected to use a stall or a restroom in the venue, locations of the stall and the restroom may be marked in the map of the venue 302 illustrated in FIG. 9D or the overall map. The visitor terminal 40 may be capable of displaying the locations of the stall and the restroom through a predetermined operation by the visitor.

When conditions for displaying the screens illustrated in FIG. 9B and FIG. 9C are simultaneously satisfied, objects included in the two screens may be displayed either concurrently or sequentially. Alternatively, the objects included in the both screens may be displayed in an overlaid manner. In this manner, when the user owns a ticket to an event on the day and a ticket to an event scheduled in the future, the electronic ticket management system 100 can execute display or processing according to an ownership status of the user.

When the user owns one or more tickets to an event scheduled in the future, the electronic ticket management system 100 is configured to display a list of summaries of the one or more tickets to the event scheduled in the future as illustrated in FIG. 9C, but may display details of the one or more tickets to the event scheduled in the future or an electronic ticket.

### Variation Example

The present disclosure is not limited to the aforementioned embodiment and available for various applications, and various variations may be made. For example, omissions or substitutions of some of the components, or addition of any given component in the embodiment described above may be made.

In the embodiment described above, the server 10 is configured to provide the visitor terminal 40 that causes the gate terminal 50 to scan an electronic ticket with route information to the seat, but the server 10 may provide the gate terminal 50 that acquires the electronic ticket with the route information. The gate terminal 50 that receives the route information may notify the visitor terminal 40 that is used to hold the electronic ticket over the gate terminal 50 of the route information by means of wireless communication or the like. In other words, the server 10 may indirectly provide the visitor terminal 40 with the route information. In this manner, even when the visitor terminal 40 cannot connect to the communication network 30, for example, due to poor reception at an installation location of the gate terminal 50, the visitor terminal 40 can receive the route information via the gate terminal 50, and the electronic ticket management system 100 can appropriately guide the visitor to the destination location.

When the gate terminal 50 receives the route information, the gate terminal 50 that receives the route information may present the route information to the visitor by displaying the route information on the display screen included in the gate terminal 50 or on a display screen installed nearby, or output the route information on paper and provide the visitor with the route information.

When one gate terminal 50 in a predetermined venue scans an electronic ticket displayed on one visitor terminal 40 and provides the one visitor terminal 40 with route information, the server 10 may not transmit the route information to the one visitor terminal 40 even if the one visitor terminal 40 causes the gate terminal 50 to scan the electronic ticket again. In this manner, the server 10 can prevent transmitting the same route information to the same visitor terminal 40 over and over again. For example, when the visitor re-enters the venue or in a similar situation, the server 10 can prevent transmitting the route information again and bothering the visitor although the visitor has already gained an understanding of the seat location.

In the embodiment described above, when detecting the operation for displaying a ticket, the visitor terminal 40 (ticketing app) is configured to display different information depending on the date and time associated with one or more tickets owned by the user. In other words, if the user owns a ticket to an event on the day, the visitor terminal 40 is configured to display an electronic ticket for the ticket; if the user does not own a ticket to an event on the day, the visitor terminal 40 is configured to display a list of one or more tickets to an event scheduled in the future or ticket information for a nearby event to be held in the neighborhood. Such a function is not mandatory, and when the visitor terminal 40 detects an operation for displaying a ticket and if the user owns a ticket to an event on the day, the visitor terminal 40 may display an electronic ticket for the ticket; if the user does not own a ticket to an event on the day, the visitor terminal 40 may display that there is no ticket to an event on the day.

When the electronic ticket management system 100 presents a route to another visitor terminal after presenting a route to one visitor terminal, the electronic ticket management system 100 may not present a route that avoids the path presented to the one visitor terminal. For example, the electronic ticket management system 100 may present a route to another visitor terminal without referring to the route presented to the one visitor terminal. In this case, the server 10 may always present the visitor terminal 40 with the shortest route from the admission gate to the destination location or present a route to be provided to the visitor based on other information such as time of day, sales of the tickets to the event on the day, and the number of visitors that have already entered.

Although in the embodiment described above, a case in which the server 10 has a function of the provider 101 has been described, the gate terminal 50 may have the function of the provider 101. In other words, the electronic ticket management system 100 may be achieved by constructing the system from the visitor terminal 40 and the gate terminal 50.

Although in the embodiment described above, a case in which the server 10 outputs the route information from the gate terminal 50 to the seat location has been described, the server 10 may output a route from the gate terminal 50 to a landmark for the seat location (for example, a stall near the seat or the like) as the route information.

In the embodiment described above, a case in which the route information from the gate terminal 50 to the seat location is presented has been described. When the visitor needs to pass through a plurality of gates in the event venue to reach the seat location from an entrance to the event venue, the electronic ticket management system 100 may change contents of the route information to be provided to the visitor terminal 40 depending on whether the electronic ticket displayed on the visitor terminal 40 is scanned by the gate terminal 50 far from the seat or the gate terminal 50 closest to the seat. For example, when the electronic ticket displayed on the visitor terminal 40 is scanned by the gate terminal 50 different from the one closest to the seat, the server 10 may generate information indicating only a direction in which the gate terminal 50 second closest to the seat is located (for example, display of an arrow) as the route information. When the electronic ticket displayed on the visitor terminal 40 is scanned by the gate terminal 50 closest to the seat, the server 10 may generate route information from the gate terminal 50 closest to the seat to the seat location.

The visitor terminal 40 may be achieved by using a conventional computer instead of a dedicated device. For example, the visitor terminal 40 that executes the processing described above may be configured by installing a program for executing the aforementioned functions on a computer included in a terminal device via a communication network.

The server 10 may be achieved by using a conventional computer instead of a dedicated device. For example, the server 10 that executes the processing described above may be configured by installing a program for executing the aforementioned functions from a recording medium storing the program on a computer. Alternatively, a single server 10 may be configured by using a plurality of computers operating in cooperation with each other.

Any given method may be employed for providing a computer with the program. For example, the program may be provided by mean of a storage medium, a communication line, a communication network, a communication system, or the like. For example, a non-transitory computer-readable recording medium storing the program for executing the aforementioned functions may be distributed.

A non-transitory recording medium may be distributed and sold independently of a computer. The non-transitory recording medium mentioned here is a tangible recording medium. The non-transitory recording medium is, for example, a compact disc, a flexible disk, a hard disk, a magneto-optical disk, a digital video disc, a magnetic tape, or semiconductor memory. A transitory recording medium is a transmission medium (propagated signal) itself. Examples of the transitory recording medium include electric signals, optical signals, and electromagnetic waves. A temporary storage area is an area for temporarily storing data or programs, for example, volatile memory such as Random Access Memory (RAM).

When a portion of the aforementioned functions is provided by an operation system (OS), portions of the functions other than the portion provided by the OS may be provided with a program.

The embodiment described above is provided for facilitating understanding of the present disclosure and is not intended to limit interpretation of the present disclosure. The elements included in the flowcharts, the sequences, and the embodiment as well as arrangements, materials, conditions, shapes, sizes, and the like thereof are not limited to those described as examples and may be appropriately changed. The components described in different embodiments may be partially substituted or combined.

### Disclosure Achieved by Present Embodiments

As described above, the present embodiments achieve the following disclosure.

### APPENDIX 1

An electronic ticket management system comprising a visitor terminal and a gate terminal, wherein
a processor of the visitor terminal outputs ticket information associated with a ticket, a processor of the gate terminal acquires the ticket information output by the visitor terminal,
the processor of the visitor terminal or the processor of the gate terminal provides the visitor terminal with route information that is information based on a route from a gate location where the gate terminal that has acquired the ticket information is located to a destination location associated with the ticket information, and
the processor of the visitor terminal presents the provided route information.

### APPENDIX 2

The electronic ticket management system according to appendix 1, wherein when the processor of the visitor terminal presents a route to another visitor terminal within a predetermined period of time after presenting a route to one visitor terminal, the processor presents a route that avoids a path presented to the one visitor terminal.

### APPENDIX 3

The electronic ticket management system according to appendix 1 or 2, wherein after presenting a route to one visitor terminal, when the processor of the visitor terminal presents a route to another visitor terminal while the route presented to the one visitor terminal is displayed, the processor presents a route that avoids a path presented to the one visitor terminal.

### APPENDIX 4

The electronic ticket management system according to any one of appendices 1 to 3, wherein when the processor of the visitor terminal receives a predetermined operation for displaying a ticket in a case in which there is a plurality of tickets associated with the visitor terminal, if the current time corresponds to an admission time of any one of the plurality of tickets associated with the visitor terminal, the processor displays ticket information associated with the ticket associated with the admission time, and if the current time does not correspond to the admission time of any one of the plurality of tickets associated with the visitor terminal, the processor displays a list of tickets associated with the visitor terminal.

### APPENDIX 5

The electronic ticket management system according to any one of appendices 1 to 4, wherein when the processor of the visitor terminal receives a predetermined operation for displaying a ticket, if the current time does not correspond to an admission time of any one of tickets associated with the visitor terminal, the processor acquires location information of the visitor terminal and searches for a ticket to an event at a venue that is reachable before an admission time in view of the location information and displays information related to a retrieved ticket.

### APPENDIX 6

An electronic ticket management method for an electronic ticket management system including a visitor terminal and a gate terminal, wherein
the visitor terminal outputs ticket information associated with a ticket,
the gate terminal acquires the ticket information output by the visitor terminal,
the electronic ticket management system provides the visitor terminal with route information that is information based on a route from a gate location where the gate terminal that has acquired the ticket information is located to a destination location associated with the ticket information, and
the visitor terminal presents the route information.

### APPENDIX 7

A visitor terminal that outputs ticket information associated with a ticket to a gate terminal, wherein the visitor terminal
receives route information that is information based on a route from a gate location where the gate terminal that has acquired the ticket information is located to a destination location associated with the ticket information, and
presents the received route information.

### APPENDIX 8

A server that
acquires ticket information output by a visitor terminal to a gate terminal from the gate terminal, and
provides the visitor terminal with route information that is information based on a route from a gate location where the gate terminal that has acquired the ticket information is located to a destination location associated with the ticket information.

### APPENDIX 9

A computer-readable recording medium on which a program is recorded, the program causing a computer to execute processing for:
outputting ticket information associated with a ticket to a gate terminal;
receiving route information that is information based on a route from a gate location where the gate terminal that has acquired the ticket information is located to a destination location associated with the ticket information; and
presenting the received route information.

### APPENDIX 10

A computer-readable recording medium on which a program is recorded, the program causing a computer to execute processing for:
acquiring ticket information output by a visitor terminal to a gate terminal from the gate terminal; and
providing the visitor terminal with route information that is information based on a route from a gate location where the gate terminal that has acquired the ticket information is located to a destination location associated with the ticket information.

### INDUSTRIAL APPLICABILITY

According to the present disclosure, an electronic ticket management system that can appropriately guide a visitor to a destination location, an electronic ticket management method, a visitor terminal, a server, and a computer-readable recording medium on which a program is recorded may be provided.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An electronic ticket management system comprising a visitor terminal and a gate terminal, wherein
a processor of the visitor terminal outputs ticket information associated with a ticket,
a processor of the gate terminal acquires the ticket information output by the visitor terminal,
the processor of the visitor terminal or the processor of the gate terminal provides the visitor terminal with route information that is information based on a route from a gate location where the gate terminal that has acquired the ticket information is located to a destination location associated with the ticket information, and
the processor of the visitor terminal presents the provided route information.

2. The electronic ticket management system according to claim 1, wherein when the processor of the visitor terminal presents a route to another visitor terminal within a predetermined period of time after presenting a route to one visitor terminal, the processor presents a route that avoids a path presented to the one visitor terminal.

3. The electronic ticket management system according to claim 1, wherein after presenting a route to one visitor terminal, when the processor of the visitor terminal presents a route to another visitor terminal while the route presented to the one visitor terminal is displayed, the processor presents a route that avoids a path presented to the one visitor terminal.

4. The electronic ticket management system according to claim 1, wherein when the processor of the visitor terminal receives a predetermined operation for displaying a ticket in a case in which there is a plurality of tickets associated with the visitor terminal, if the current time corresponds to an admission time of any one of the plurality of tickets associated with the visitor terminal, the processor displays ticket information associated with the ticket associated with the admission time, and if the current time does not correspond to the admission time of any one of the plurality of tickets associated with the visitor terminal, the processor displays a list of tickets associated with the visitor terminal.

5. The electronic ticket management system according to claim 1, wherein when the processor of the visitor terminal receives a predetermined operation for displaying a ticket, if the current time does not correspond to an admission time of any one of tickets associated with the visitor terminal, the processor acquires location information of the visitor terminal and searches for a ticket to an event at a venue that is reachable before an admission time in view of the location information and displays information related to a retrieved ticket.

6. An electronic ticket management method for an electronic ticket management system including a visitor terminal and a gate terminal, wherein
the visitor terminal outputs ticket information associated with a ticket,
the gate terminal acquires the ticket information output by the visitor terminal,
the electronic ticket management system provides the visitor terminal with route information that is information based on a route from a gate location where the gate terminal that has acquired the ticket information is located to a destination location associated with the ticket information, and
the visitor terminal presents the route information.

7. A visitor terminal that outputs ticket information associated with a ticket to a gate terminal, wherein the visitor terminal
receives route information that is information based on a route from a gate location where the gate terminal that has acquired the ticket information is located to a destination location associated with the ticket information, and
presents the received route information.

8. A server that
acquires ticket information output by a visitor terminal to a gate terminal from the gate terminal, and
provides the visitor terminal with route information that is information based on a route from a gate location where the gate terminal that has acquired the ticket information is located to a destination location associated with the ticket information.

9. A computer-readable recording medium on which a program is recorded, the program causing a computer to execute processing for:
outputting ticket information associated with a ticket to a gate terminal;
receiving route information that is information based on a route from a gate location where the gate terminal that has acquired the ticket information is located to a destination location associated with the ticket information; and
presenting the received route information.

10. A computer-readable recording medium on which a program is recorded, the program causing a computer to execute processing for:
acquiring ticket information output by a visitor terminal to a gate terminal from the gate terminal; and
providing the visitor terminal with route information that is information based on a route from a gate location where the gate terminal that has acquired the ticket information is located to a destination location associated with the ticket information.
